(19) United States
(12) Patent Application Publication
(10) Pub. No.: US 2004/0012170 A1
(43) Pub. Date: Jan. 22, 2004

(54) Accessory mounting adapter for a trailer hitch assembly

(76) Inventor: Richard W. McCoy, Granger, IN (US)

Correspondence Address: KING & SCHICKLI, PLLC, 247 NORTH BROADWAY, LEXINGTON, KY, 40507, US

(21) Appl. No.: 10/415,062

(22) PCT Filed: Oct. 2, 2001
(86) PCT No.: PCT/US01/30796

(51) Int. Cl. B60D 1/58

(52) U.S. Cl. 280/495; 224/519

(57) ABSTRACT

An accessory mounting adapter (30) includes a cross member (32), a mounting bar (34) carried on that cross member (32) and extending in a first plane P1 and a pair of accessory ports (48) adapted to allow two-point connection to an accessory. Each accessory port (48) extends in a second plane P2 where planes P1 and P2 define an acute included angle of between substantially about 10 degrees to about 30 degrees.

This application claims the benefit of U.S. Provisional Patent Application Serial No. 60/243,382 filed on Oct. 26, 2000.

### TECHNICAL FIELD

The present invention relates generally to the vehicle accessory field and, more particularly, to an adapter for mounting accessories with multiple mounting bar systems into the receiver box of a standard trailer hitch assembly.

### BACKGROUND OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Ind. Such a hitch receiver is also disclosed in, for example, U.S. Pat. No. 3,768,837 to Reese, owned by Reese Products, Inc.

Recent efforts to enhance the versatility of a hitch receiver have led to development of various accessories (e.g., both open and closed article carriers, bike racks, ski racks, tables, winches or other equipment) mounted by means of an accessory mounting bar or lug in the receiver box of a trailer hitch receiver assembly. Because of their convenience and suitability to the particular applications/interests of the user, such accessories have become very popular.

In order to allow for or accommodate trailer towing and accessory mounting simultaneously, a trailer hitch assembly with both a trailer hitch receiver and towing accessory receivers has been recently developed and is the subject of, for example, U.S. Patent Application Serial No. 60/194,502, filed Apr. 3, 2000 and 60/243,486, filed Oct. 26, 2000. This new trailer hitch receiver assembly includes a central frame member, a mounting bracket carried on each end of the central frame member for securing the central frame member to the vehicle, a hitch receiver box carried on the central frame member and two accessory receivers for receiving and holding a recreational and/or utilitarian accessory. The two point mounting for the accessory greatly increases the stability of the mounting arrangement. Accordingly, a number of accessories will be manufactured and marketed with multiple mounting posts, lugs or bars in order to take advantage of this new arrangement.

The present invention relates to an adapter that may be utilized to mount accessories manufactured with the new multiple mounting lug, bar or post system on “standard” trailer hitch assemblies that incorporate only a hitch receiver. Thus, the old trailer hitch assemblies in the field may be conveniently adapted to receive and hold the new multipost/multibar mounting accessory products.

### SUMMARY OF THE INVENTION

In accordance with the purposes of the present invention as described herein, an accessory mounting adapter is provided for a trailer hitch assembly incorporating a receiver box. The adapter includes a cross member, a mounting bar carried on the cross member for securing in the receiver box of the trailer hitch assembly and a pair of spaced accessory receivers allowing two-point mounting of an accessory of a type incorporating multiple mounting posts or bars.

More particularly describing the invention, the mounting bar is square in cross section and the accessory receivers are circular in cross section. The accessory receivers project upwardly from the cross member at an acute included angle (i.e. from about 10° to about 30°) and include a side wall having a pair of opposed apertures for receiving a pin to secure an accessory thereto. The mounting bar also includes a pair of opposed side walls each including a pin receiving aperture whereby the adapter may be secured in the receiver box of a trailer hitch assembly.

The invention may also be described as comprising a T-shaped body carrying a pair of accessory receivers allowing for two point mounting of an accessory.

Still other objects of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrates several aspects of the present invention and together with the description serves to explain the principles of the invention. In the drawings:

FIG. 1 is a perspective view of a typical or standard trailer hitch assembly incorporating a single centrally located receiver box as commonly utilized to tow a trailer;

FIG. 2 is a perspective view of the adapter of the present invention;

FIG. 3 is a side elevational view of the adapter shown in FIG. 2; and

FIG. 4 shows how the adapter is utilized to mount a multiple mounting post/bar accessory to a trailer hitch assembly incorporating only a receiver box.

Reference will now be made in detail to the present preferred embodiment of the invention, an example of which is illustrated in the accompanying drawings.

### DETAILED DESCRIPTION OF THE INVENTION

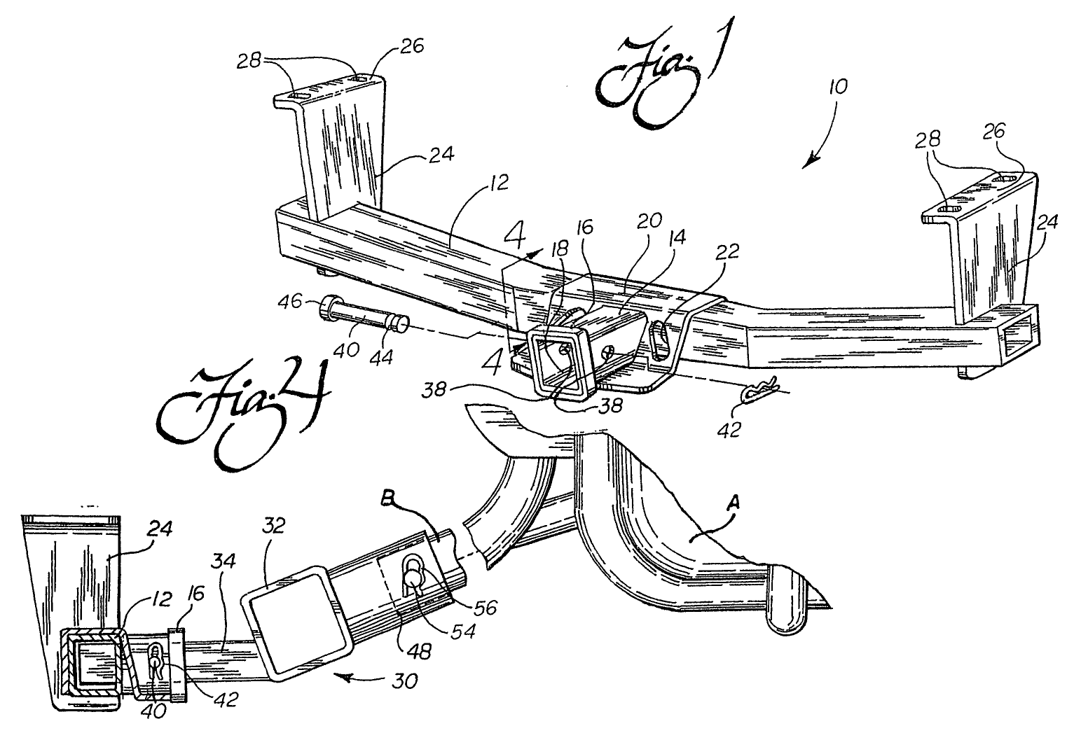

Reference is now made to FIG. 1 illustrating a typical or standard trailer hitch receiver assembly, generally designated by reference numeral 10 which is mounted to the frame of a towing vehicle. The trailer hitch assembly 10 includes a cross bar 12 formed from tubular steel. A receiver box 14, also formed from tubular steel, is welded to the cross bar 12. The receiver box 14 includes a reinforced lip 16 defining a cavity 18 sized and shaped to receive and hold a hitch or draw bar (not shown) of the type that carries a hitch ball or other means allowing connection to a trailer. A chain plate 20 formed from a steel plate is welded to both the cross bar 12 and receiver box 14 to enhance the rigidity of the overall structure and provide openings 22 for receiving the safety chains of a trailer during towing.

The trailer hitch assembly 10 also includes a pair of mounting brackets 24 which may also be formed from steel plate material. One mounting bracket 24 is welded to the cross bar 12 adjacent each end thereof. Each mounting bracket 24 includes a mounting flange 26 and each mounting flange includes two or more apertures 28. Nut and bolt fasteners (not shown) are extended through these apertures 28 and cooperating apertures drilled in the frame of the towing vehicle in order to mount the trailer hitch assembly 10 thereto.

The accessory mounting adapter 30 of the present invention is shown in FIG. 2. The adapter 30 includes a T-shaped body having a cross member 32 and a mounting bar 34 that both extend in a first plane Pa. The mounting bar 34 is sized, shaped and adapted for receipt in the receiver box 14 of the trailer hitch assembly 10. When properly mounted in the receiver box 14, cooperating apertures 36 in the side walls of the mounting bar 34 are aligned with cooperating apertures 38 in the opposing side walls of the receiver box. A connecting pin 40 is passed through the apertures 36, 38 and a pin clip 42 is secured in the groove 44 on the end of the connecting pin opposite the head 46 (see also FIG. 4). The cross member 32 and the mounting bar 34 may both be formed from steel tubing and then secured together as an integral component by welding or other appropriate means.

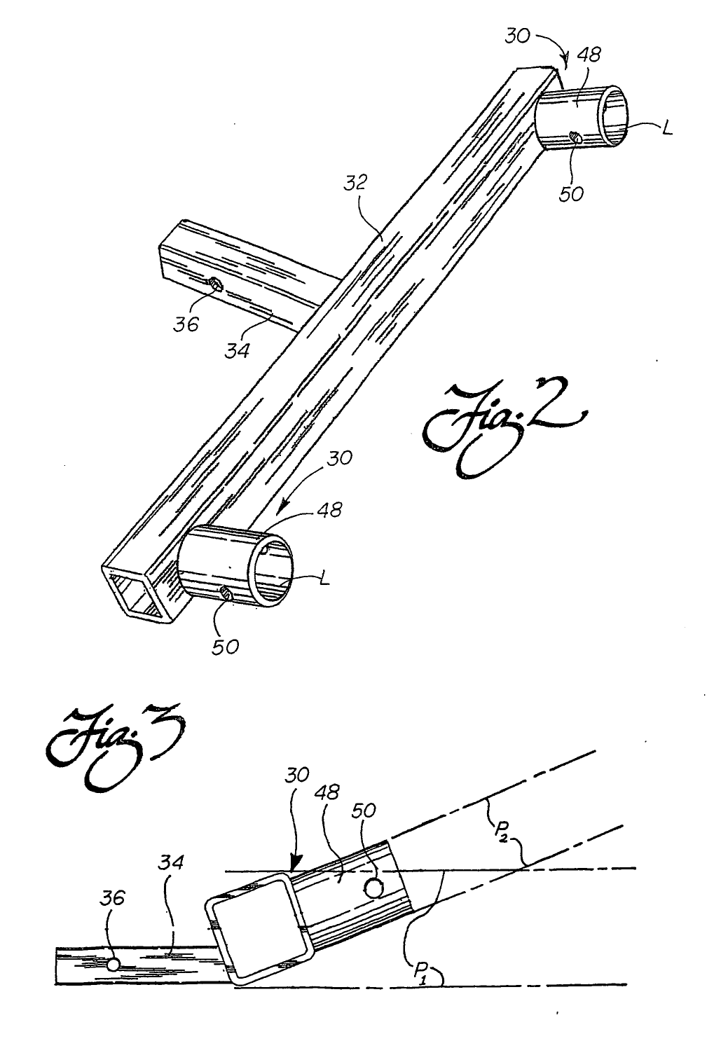

Multiple accessory receivers 48 are mounted to and carried on the cross member 32. Each accessory receiver 48 may be formed from tubular steel material. One accessory receiver 48 is welded to the cross member 32 adjacent each end thereof. As shown in FIG. 2, each receiver 48 provides a circular port or opening 50 for receiving a mounting post, lug or bar B of an accessory A (see also FIG. 4). As further shown in FIG. 3, each receiver 48 projects upwardly in a plane P. As shown in FIG. 3, planes P₁ and P₂ define an acute included angle of, for example, between 10-30° (e.g. 20°).

It should be appreciated that the structural arrangement of the mounting bar 34 and accessory receivers 48 benefits the user when attempting to attach a recreational and/or utilitarian accessory. When attached to the trailer hitch assembly 10, the accessory mounting adapter 30 projects rearwardly out from under the bumper of the vehicle to which the towing hitch assembly is secured. Additionally, the accessory receivers 48 project upwardly at an angle of from about 10° to about 30° with respect to the mounting bar 34 and cross member 32. Thus the circular ports or openings 50 of the accessory receivers 48 are both readily visible and accessible.

Due to this fact, it is relatively easy for the user to engage the openings 50 of the accessory receivers 48 with the mounting posts B of a recreational and/or utilitarian accessory A such as the cargo carrier platform partially illustrated in FIG. 4. At this point the circular shape of the accessory receivers 48 and cooperating mounting posts B concentrically received therein further insure ease of connection. Specifically, since the ports B and the receivers 48 are both round, they present continuous, uninterrupted mating side walls. Accordingly, it is not necessary to index the posts B in any way to insure proper geometry for mating: simple alignment is all that is necessary. Additionally, the posts B may be flexed slightly in virtually any direction during mating as an additional aid when making the connection.

Of course, it should also be appreciated that the angular orientation of the receivers 48 means that the lower edge of the receivers project rearwardly from the vehicle slightly more than the upper edge of the receivers so that the lower edge forms a ledge or lip upon which a substantial portion of the weight of the accessory A may be supported during the connection process. This makes manipulation of the accessory even easier during connection.

Once properly aligned, the posts B slide readily into the receivers 48. When fully seated, cross apertures (not shown) in the posts B are in alignment with the aligned apertures 52 in the receivers 48. A connecting pin 54 is then positioned in these apertures 52 and a pin clip 56 is used to secure the pin in position.

The upward angular orientation of the accessory receivers 48 also provides a number of additional advantages that are, perhaps, not readily apparent. The angular orientation functions to provide a lower lip L on each accessory receiver 48 which projects outwardly beyond the upper portion of the receiver and therefore acts as a shelf or shoulder to support the weight of the accessory when the posts or bars B are initially inserted.

The upward angular orientation of the receivers 48 also insures a secure connection between the bars B and receivers. Specifically, this arrangement insures that gravity works with the operator to properly seat the bars B on the receivers 48 during connection of the accessory A. The upward inclination also functions to effectively raise the accessory A from the ground so that it will clear most curbs and other like obstacles that one might expect to meet during vehicle operation.

The upward inclination also introduces a moment into the linkage between the accessory A and the receiver assembly 10 so that forward acceleration of the vehicle does not produce only rearward movement forces on the accessory.

The foregoing description of the preferred embodiment of this invention has been presented for purposes of illustration and description. It is not intended to be exhaustive or to limit the invention to the precise form disclosed. Obvious modifications or variations are possible in light of the above teachings. For example, while only two accessory receivers 48 are shown on the accessory mounting adapter 30, substantially any reasonable number may be provided to allow multipoint connection between the adapter 30 and the accessory A carried thereby. Additionally, while the ports or openings 50 and the accessory receivers 48 are circular in cross section, it should be appreciated that substantially any shape opening allowing connection to a mounting post may be utilized (e.g., triangular, square, rectangular, elliptical, pentagonal, hexagonal).

It should also be appreciated that while hollow accessory receivers are illustrated, the accessory receivers could just as easily be solid bars or rods so long as the accessory mounting posts or lugs are of a complementary shape necessary to allow interconnection. Further, connection of the mounting posts/bars of the accessory in the receivers 48 may be made by means other than the connecting pin 54 and pin clip described (e.g., cooperating ball and detente). Of course, materials other than steel may be utilized to construct any or all of the component parts of the apparatus including the trailer hitch assembly 10, the accessory mounting adapter 30 and the mounting posts or bars B of the accessory.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An accessory mounting adapter for a trailer hitch assembly including a receiver box, comprising:
a cross member;
a mounting bar carried on said cross member, said mounting bar extending in a first plane P₁; and
a pair of spaced accessory receivers allowing two-point mounting of an accessory, said pair of spaced accessory receivers extending in a second plane P₂ where P₁ and P₂ define an acute included angle.

2. The adapter of claim 1 wherein said mounting bar is square in cross section.

3. The adapter of claim 1, wherein said pair of accessory receivers are circular in cross section.

4. The adapter of claim 1, wherein each of said pair of accessory receivers project from said cross member and include a side wall having a pair of opposed apertures for receiving a pin to secure an accessory thereto.

5. The adapter of claim 1, wherein said mounting bar includes a pair of opposed side walls, each of said pair of opposed side walls including a pin receiving aperture whereby said adapter is secured in the receiver box of the trailer hitch assembly.

6. The adapter of claim 1, wherein said included angle is from about 10° to about 30°.

7. The adapter of claim 1 wherein said included angle is about 20°.

8. An accessory mounting adapter for a trailer hitch assembly including a receiver box, comprising:
a T-shaped body, and
a pair of accessory receivers carried on said T-shaped body allowing for two-point mounting of an accessory.

9. The adapter of claim 8, wherein said pair of accessory receivers are circular in cross section.
